(19) United States
(12) Patent Application Publication
(10) Pub. No.: US 2022/0242200 A1
(43) Pub. Date: Aug. 4, 2022

(54) COATING DELETION FOR ELECTRICAL CONNECTION

(71) Applicant: CENTRAL GLASS CO., LTD., Ube-shi, Yamaguchi (JP)

(72) Inventor: Katharina Boguslawski, Trier (DE)

(73) Assignee: Central Glass Company, Limited, Ube-shi, Yamaguchi (JP)

(21) Appl. No.: 17/613,554

(22) PCT Filed: May 29, 2020
(86) PCT No.: PCT/US20/35126

§ 371 Date: Nov. 23, 2021

Related U.S. Application Data
(60) Provisional application No. 62/853,865, filed on May 29, 2019.

(51) Int. Cl. B60J 1/00; B32B 17/10; C03C 17/36; H05B 3/84

(52) U.S. Cl. CPC B60J 1/002; B60J 3/04; B32B 17/10192; B32B 17/10229; B32B 17/10348; B32B 17/10761; C03C 17/366; C03C 17/3673; C03C 17/3681; C03C 17/3639; C03C 17/3655; C03C 17/3644; B60J 1/001; H05B 3/84; B32B 2605/00; C03C 2218/33; B32B 17/10036

(57) ABSTRACT

A method for producing an electrically connected coated substrate for vehicle glazing includes the steps of providing on a surface of a substrate a coating having a conducting layer, forming an opening in the coating, and applying an electrical connector having a conductive carrier on one side of the electrical connector to the coating directly over the opening, wherein the conductive carrier fills the opening to electrically connect the conducting layer.

### CROSS REFERENCE TO RELATED APPLICATION

This application claims priority to U.S. Provisional Application No. 62/853,865 filed on May 29, 2019, entitled “COATING DELETION FOR ELECTRICAL CONNECTION,” the content of which is incorporated by reference herein in its entirety.

### TECHNICAL FIELDS

The present disclosure generally relates to a method for producing an electrically conductive laminated vehicle glazing (e.g., vehicle windshield) and an electrically conductive laminated vehicle glazing. More specifically, this disclosure relates to a busbar creation by coating deletion technology to provide one or more electrical connections to a conductive coating on/in laminated vehicle windows.

### BACKGROUND

Conductive coatings on a vehicle window may have various uses, including heating the window. Heatable laminated vehicle windows may be configured to melt snow, ice or frost, which may be especially useful during winter seasons or in cold areas. Such a heatable function may be provided by an infrared reflective (IRR) coating on the laminated vehicle windows which also significantly reduces infrared solar radiation into a vehicle and improves comfort in the vehicle.

Heatable IRR coating technology for automotive glazing may provide a coating comprising at least one conductive layer of metallic silver, typically two or three metallic silver layers deposited by physical vapor deposition (PVD) (e.g., vacuum sputtering) or chemical vapor deposition (CVD) technologies. The heatable IRR coating may also comprise several other thin layers for matching desired refractive indices, promoting adhesion, compensating for thermal expansion and/or reducing corrosion or scratches during production (e.g., during a bending process) or actual usage. Each thin film layer in the heatable IRR coating may have a thickness of a few tens nanometers such that the heatable IRR coating may be transparent or semi-transparent.

While the metallic silver layers in the heatable IRR coating are electrically conductive, most of the other layers, including a top layer, may be dielectric or insulators, hence electrically non-conductive (e.g., metal oxides, metal nitride or metal oxynitride). A busbar may include a strip of conductive material, such as silver, screen printed onto an exposed surface of a conductively coated glass. Electric voltage may be provided via a silver busbar from an external power source (e.g., a DC battery in a vehicle) to silver layers in the heatable IRR coating in an automotive laminated window.

In a conventional manufacturing process of a heatable laminated vehicle window known in the art, a heatable IRR coating may be deposited on the glass surface with optional screen printing of silver paste enamel for busbar arrangement on the glass surface. The silver paste enamel may then be dried and pre-fired. After assembling the outer and inner glass panes, the glass panes may be simultaneously bent through a known gravity-sag bending process. During this thermal bending process, the silver particles in the busbar may migrate and penetrate the heatable IRR coating through non-electrically conductive sub-layers and create electrical connection between the electrically conductive silver layers in the coating and the external power source. The migration and penetration of the silver particles may occur during any suitable firing process.

Such a silver busbar may create an uneven beating profile on the glass substrate and undesirable residual stress around the silver busbar as heat may be more concentrated in the area of the silver busbar. The resulting glass substrate may have reduced strength in the area of the silver busbar which was heated differently than the rest of the glass substrate, which did not have a silver busbar. Further, the heat treatment of the silver busbar may form a strong bond to the glass substrate, such that any fractures in the silver busbar may expand to the glass substrate and result in breakage of the glass substrate. The silver busbar may cause a weaker surface than the glass substrate and may more easily fracture in such a way.

### SUMMARY OF THE DISCLOSURE

Disclosed herein is a method for producing an electrically connected coated substrate comprising the steps of: providing on a surface of a substrate a coating having a conducting layer; creating a deletion in the coating to form an opening; and applying an electrical connector having a conductive carrier on one side of the electrical connector to the coating directly over the opening, wherein the conductive carrier fills the opening to electrically connect the conducting layer.

In another aspect of the disclosure, a vehicle glazing includes a first substrate having first and second surfaces wherein the first surface faces a vehicle exterior, a second substrate having third and fourth surfaces wherein the fourth faces a vehicle interior, a polymer interlayer formed between the first substrate and the second substrate, a coating formed on either one of the second and third surfaces, including a conductive layer, the coating being formed with an opening to expose the conductive layer, and an electrical connector having a conductive carrier on one side of the electrical connector, the electrical connector being applied to the coating directly over the opening to electrically connect the conductive layer.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a process for laser structuring in a method for producing a vehicle glazing using a heatable IRR coating according to the present disclosure:

FIG. 2 illustrates a process for applying a conductive tape in the method for producing a vehicle glazing according to the present disclosure;

FIG. 3 illustrates a process for forming an electrical connector in the method for producing the vehicle glazing according to the present disclosure:

FIG. 4 illustrates a process for making lamination in the method for producing the vehicle glazing according to the present disclosure;

FIG. 5 illustrates a laser etching process performed on a coating on a glass according to an exemplary aspect of the present disclosure;

FIG. 6 illustrates a conductive tape applying process on an opening according to an exemplary aspect of the present disclosure;

FIG. 7 illustrates an electrical wiring process according to an exemplary aspect of the present disclosure;

FIG. 8 is a cross section showing a detail around an opening in the conductive tape applying process according to an exemplary aspect of the present disclosure:

FIG. 9 illustrates a coating forming process according to another exemplary aspect of the present disclosure:

FIG. 10 illustrates a laser etching process according to another exemplary aspect of the present disclosure;

FIG. 11 illustrates a tape application process according to another exemplary aspect of the present disclosure;

FIG. 12 illustrates a filling opening process according to another exemplary aspect of the present disclosure;

FIG. 13 illustrates a connector soldering process according to another exemplary aspect of the present disclosure;

FIG. 14 illustrates a glass and interlayer polymer assembling process according to another exemplary aspect of the present disclosure; and

FIG. 15 illustrates a flowchart showing a method for producing a vehicle glazing according to yet another exemplary aspect of the present disclosure.

### DETAILED DESCRIPTION

In the following description, for purposes of explanation, specific details are set forth in order to promote a thorough understanding of one or more aspects of the disclosure. It may be evident in some or all instances, however, that any aspects described below can be practiced without adopting the specific design details described below. This disclosure relates to solutions for any conductive coating, including those having one or more conductive layers in a coating stack or other formulations of conductive material. The descriptions herein may refer to a particular embodiment, however, the application may not be limited to a particular conductive coating material.

There is a need to bend a glass pane precisely in various applications, including the creation of a large projection area for head-up display (HUD) or in manufacturing complicated shapes to improve design capability, such as a large panoramic windshield. Gravity sag bending, where inner and outer glass panes are stacked through the bending process, may not be able to provide such precise bending shapes. More precise bending processes, which may include a press for attaining a desired shape, may require the glass substrates to be bent individually, rather than in a stacked pair.

The inventors surprisingly found that the methods and products described herein provide conductive power necessary to heat a coating across a glazing, including a windshield. Particularly, the methods and products described herein may be used to heat a coating applied to a glazing, such as a windshield, and may be coated on a majority of the glazing. In the following description, single glass bending processes or paired glass bending processes, such as gravity sag bending, may be used.

Disclosed herein, among other features, is a process of forming at least one opening in a coating to provide an electrical connection to conductive layers in the coating. The openings may be formed before or after a thermal bending process. The openings may be formed by any suitable means, including, but not limited to, physical abrasion, chemical etching, or laser etching. The openings described herein may extend through all or part of the coating. The coating may include conductive and non-conductive materials in any form, including stacked and non-stacked materials

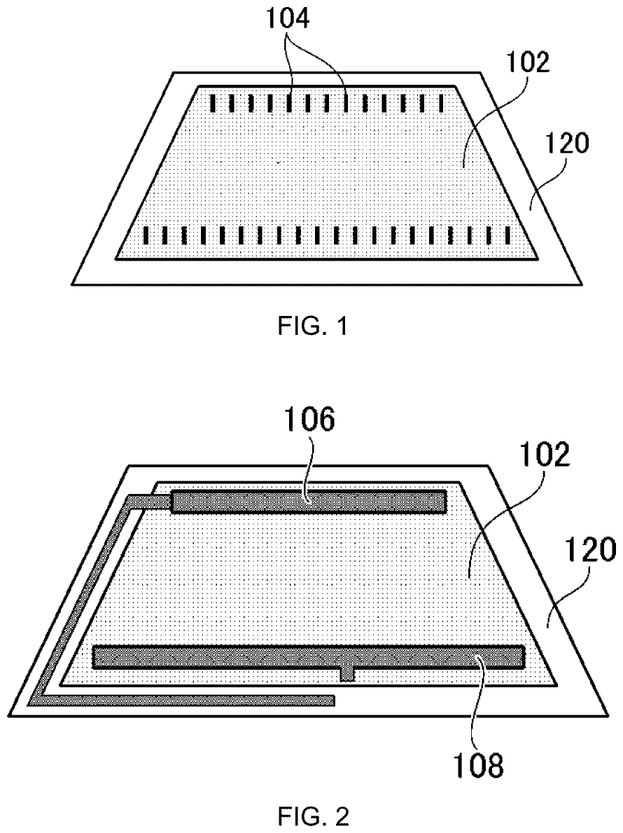

Referring to FIGS. 1 to 4, a production method for a vehicle glazing is illustrated. First, as shown in FIG. 1, a large flat glass substrate 120 or glass pane, typically made of, e.g., soda-lime glass substrate/pane manufactured by a float method known in the art, may be prepared and cut to be in a desired size and shape for production. The glass substrate 120 may have a thickness about from 0.05 mm to 10.0 mm, preferably about from 0.5 mm to 3.0 mm, and more preferably about from 1.0 mm to 2.4 mm. To assemble a vehicle glazing, a pair of glass substrates, namely a first glass substrate and a second glass substrate, may be used, and either one of the glass substrate may be formed with a heatable coating.

A heatable coating 102 may be applied to a glass substrate 102 before or after the glass substrate 120 is cut and before or after the glass substrate 120 is bent. In some embodiments, the heatable coating 102 may include multiple dielectric layers and at least two conductive layers including of silver. The thickness of the heatable coating 102 may be thin and may be in a range of several nanometers to several sub-micrometers, preferably in a range of about 100 to 500 nm. The conductive layers may be positioned between dielectric layers such that the conductive layers are electrically isolated, and coating layers may be generally formed by chemical deposition, sputtering, or any other methods known in the art. The top layer of the heatable coating 102 may be electrically non-conductive and may serve as an insulation layer.

The glass substrate 120 formed with the heatable coating 102 may be subject to grinding and bending. The bending process may include a gravity-sag bending or a press bending process, during which the glass substrate 120 made of soda-lime glass may be heated and bent to obtain a required three-dimensional shape, which may include cylindrical or spherical shapes, to be fit for a vehicle window. It may be desirable for the heatable coating 102 to survive before and after heat treatment (e.g., during a thermal tempering or bending process), i.e., to be mechanically and/or chemically durable. For example, it may be desirable that the heatable coating 102 does not oxidize, have visible light transmittance less than 70%, or show defects. In some embodiments, a heatable coating 102 may be applied to the glass substrate 120 after the bending process.

Laser structuring may be formed after the bending process. As shown in FIG. 1, openings 104 may be formed in the heatable coating 102 on the glass substrate 100. In some embodiments, the opening may be formed by a laser which deletes portions of the heatable coating 102, leaving the openings 104. Preferably, an opening 104 reaches at least one conductive layer or conductive part in the heatable coating 102 and more preferably, the opening 104 reaches each conductive layer or conductive part in the heatable coating 102. The opening(s) 104 may be formed such that each of the coating 102's conductive layers or parts are exposed through the opening(s) 104. Each opening 104 may, in some embodiments, be formed in a linear shape and may be formed with a periodical pattern of lines. The opening(s) 104 may be in any shape to expose conductive layers or elements of a coating, including circles, ovals, islands, waves, pillars, or linear forms. An island-shaped opening may include a coating deletion surrounding an undeleted portion of heatable coating 102. Such openings 104 may be arranged near an edge of the glass substrate 120 as to render other areas remain without openings. Particularly, openings 104 may be formed near a top edge and a bottom edge of the glass substrate 120 or near a left edge and a right edge of the glass substrate 120, such that the openings may be formed on opposite edges of the glass substrate 120.

After forming the openings 104, electrical tape serving as electrical connectors may be attached over the openings 104, as shown in FIG. 2. The electrical tape may include copper tape 106, 108 and a conductive carrier arranged on the copper tape. The copper tape may be surface-treated with, e.g., a pre-tinning process, for improved soldering of a connectors to the copper tape. The copper tape 106, 108 may have a width of about 6 to 10 mm, and preferably about 6 to 8 mm, for serving as a busbar for electrically connecting to the conductive layers in the heatable IRR coating 102 via the openings 104. The copper tape 106, 108 may include a conductive carrier which may contain metallic particles or other conductive particles dispersed in an adhesive vehicle. The conductive carrier may be an adhesive. In this embodiment, the copper tape may be provided with a conductive adhesive on one side of the tape, and the conductive adhesive may be covered with a release paper or film which may be removed prior to application of the copper tape to the glass substrate 120. When the copper tapes 106, 108 are applied, the front side of the copper tapes 106, 108 may be pushed against the glass substrate 120 so as to adhere the copper tapes 106, 108 to the prescribed areas. During this application process, the conductive carrier may change its shape as to fit into the shape of the openings 104 without the application of any additional heat. The conductive carrier may then be electrically connected to the exposed conductive layers in the heatable coating 102 as described below.

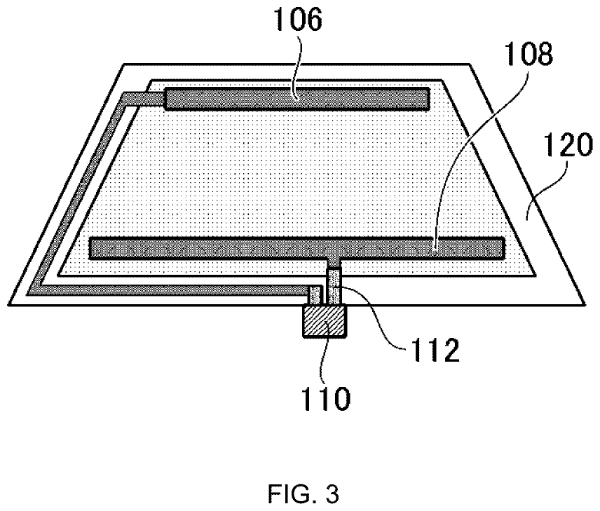

A connector 112, which may include a flex connector, may further be provided on the copper tapes 106, 108 via a soldering paste, not shown, applied by any suitable soldering process. The connector 112 may be coupled to a joint member 110 placed outside the area of the glass substrate 120, as shown in FIG. 3.

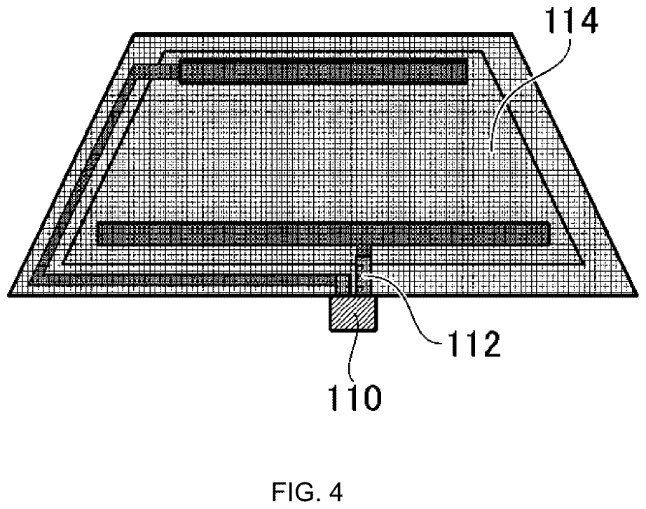

After the connector 112 is provided, the glass substrate 120 may be laminated with another glass substrate to provide a vehicle glazing as shown in FIG. 4. Lamination may include positioning an interlayer 114 made of, e.g., polyvinyl butyral (PVB), typically about 0.85 mm or less in thickness, over the glass substrate 120 and the copper tapes 106, 108 and further positioning another glass substrate over the interlayer 114.

According to the above processes, the copper tapes are not subject to any thermal treatment processed at a temperature higher than the glass softening point such that the glass bending process may not be affected by the presence of a busbar which may otherwise be formed on the glass. The copper tapes may be handled easily by an operator or machine and secured without any further thermal treatment.

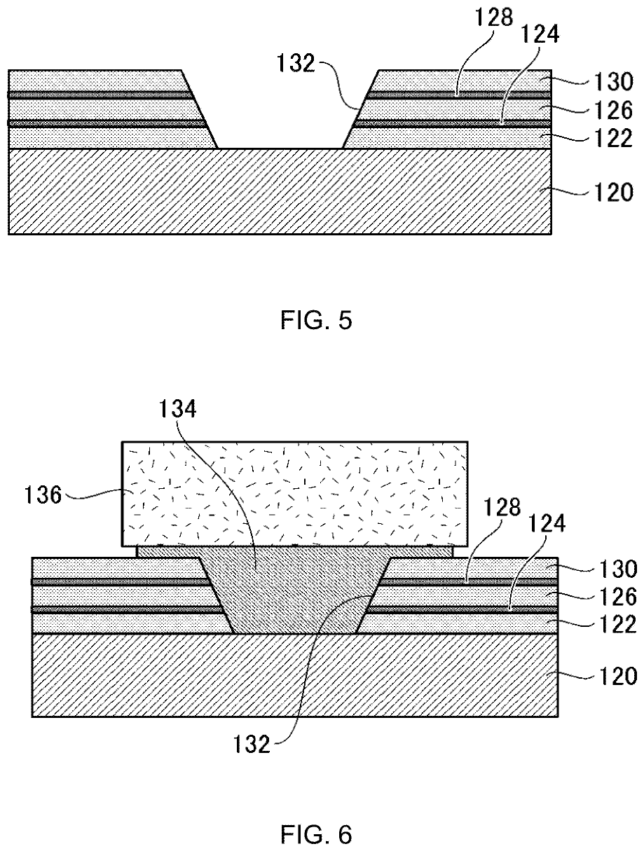

The method disclosed herein may provide for suitable production of a glazing capable of electrical connection. Referring to FIGS. 5 to 7, detailed processes for formation of openings and electrical connections are illustrated. As shown in FIG. 5, a glass substrate 120 may be prepared having a heatable coating, which may be formed by sputtering or deposition of thin films. The heatable coating may include a lower dielectric layer 122, a lower silver layer 124, a middle dielectric layer 126, an upper silver layer 128, and an upper dielectric layer 130. Each of the lower 122, middle 126, and upper 130 dielectric layers may consist of one or more dielectric layers comprising the same or different materials. Suitable dielectric materials may include titanium oxide (TiOₓ), silicon nitride (SiₓN_{y}), silicon oxide (SiOₓ), niobium oxide (Nb₂O₅), aluminum oxide (e.g., Al₂O₃), silicon zirconium nitride (SiₓZr_{y}N_{z}), tin oxide (SnOₓ), zinc oxide (ZnOₓ), silicon oxynitride (SiₓO_{y}N_{z}) and combinations thereof, or any other suitable dielectric material. The lower and upper silver layers 124, 128 may serve as the conductive layers of the heatable coating and may include silver (Ag). Alternatively, conductive layers may include gold, copper, titanium, nickel, chrome, or any other suitable conductive material, such as a transparent conductive oxide (TCO), including indium tin oxide (ITO), and may preferably be metallic. The conductive material may further be infrared reflecting. As described above, where a heatable coating comprising three or more silver layers, a total layer thickness T of the heatable coating comprising three silver layers may be comparatively thicker than the total thickness T of a heatable coating comprising two silver layers. For example, the total thickness T of a heatable coating comprising three silver layers may preferably be in the range of about 300 to 500 nano meters while that of a heatable coating comprising two silver layers may preferably be in the range of about 150 to 250 nano meters. A silver layer may preferably have a thickness of 5 to 20 nano meters, more preferably 9 to 12 nano meters. The heatable coating 102 may be formed on the glass substrate 120 before or after the glass substrate 120 is bent by a suitable glass bending method.

In certain embodiments, an opening 132 may be formed in the heatable coating 102 by a laser etching method. In further embodiments, the opening 132 may be formed by another suitable method, including mechanical ablation, a combination of methods. The opening 132 in the heatable coating may extend through each silver layer 124, 128 of the coating but may not extend beyond the surface of the glass substrate 120. The opening 132 may extend through one but not all of the silver layers in some further embodiments. The opening 132 may have a slant side wall as shown in FIG. 5 but may be formed with an upright wall perpendicular to the surface of the glass substrate 120. In some embodiments, the layered coating stack structure within the opening 132 may resemble a layered vertical surface, similar to a cliff exposing the geological stratum layers made of the different minerals accumulated over time. The silver layers 124, 128 may be exposed at an inner side surface of the opening 132, wherein such exposure may be the thickness of the silver layers 124, 128.

A heatable coating, in some embodiments, may comprise three silver layers. It should be appreciated that other conductive coating designs, stacked and non-stacked, may be contemplated according to aspects of the present disclosure, including coatings having more, less than, or equal to three silver layers, nanowire coatings, and low-emissivity coatings. In some embodiments, conductive coatings may include materials, such as metallic layers or transparent conductive oxides (e.g., indium tin oxide), having a non-conductive top coating for, e.g., better handling capabilities.

In some exemplary embodiments of the present disclosure, the coating may extend across a majority of the substrate. There may be one or more portions of the substrate which remain uncoated; however, the substrate may have more surface area that is coated than surface area that is uncoated. In some embodiments, the substrate may be entirely coated and a portion of the coating is removed to provide an uncoated area, separate from the openings described herein. In certain embodiments, the openings may have a wave pattern which may have a periodic or non-periodic structure. In some embodiments, the opening may have a sinusoidal wave, triangle wave or quadrangular wave structure. A wave pattern opening may be formed by a discontinuous deletion. For example, a series of separate deletions may be made to form a wave pattern. This may include the creation of individual openings formed in line with each other to appear as a wave. The individual openings may further include a crater shaped form having a hill within the opening such that the wave pattern may have varying hill heights. For example, the hill heights may fall at and/or below the coating surface height. The opening may further be formed as vertical pillars to expose conductive materials. In this specification, the term of “vertical pillar” refers to an opening having an inside wall or edge extending perpendicular to the major surface of the glass substrate.

Further, non-wave or pillar structures may be used to expose lower conductive layers or materials of a coating, including linear openings. A linear shaped opening may include a linear opening formed through the coating, which may include, but is not limited to, a straight, or substantially straight line. In some embodiments, a linear shaped opening may include at least one curve or turn. The linear shaped opening may be any shape to increase contact to underlying conductive layers, including perpendicular and/or non-perpendicular deletions with respect to the coating surface. Preferably, the linear openings may be less than or equal to 15 mm long, and more preferably, less than or equal to 12 mm long. Preferably the linear openings within a busbar area may be spaced equal to or less than 5 mm apart; more preferably, less than or equal to 3 mm apart; and more preferably, less than or equal to 1.5 mm apart. Linear openings may be directional, as they may be longer in one direction. Linear openings may be preferably parallel to an electrical current in the conductive coating and perpendicular to a connector which may be applied thereto, such as a copper tape applied over the openings. Where the linear openings are formed perpendicular to the current, it is possible to cut off the connection, preventing any electrical connection. A lower resistance may be possible where the deleted openings are parallel to the electric current.

A pattern of openings, in any shape or form, may be periodic or non-periodic. Preferably, the pattern may be formed in an area for busbar connection. More preferably, the pattern may be formed across the entire busbar area. The frequency of openings may affect the electrical connection that may be formed at the openings. The openings may provide access to conductive material to create electrical connection thereto. Providing more access to the conductive material may provide an improved connection at the busbar, decreasing contact resistance and increasing homogeneity of the electrical connection.

Laser power sources known in the art for laser deletion for an automotive glazing for electric sensor installation may be used to provide openings in a coating. For example, equipment producing a pulsed green laser with a wavelength of 532 nm and frequency of 10 kHz or an infrared laser having a wavelength of 1059 to 1065 nm may be used. Moreover, power, pulsation and/or frequency may be periodically or non-periodically varied or scanned. Variation of laser focus during scanning with or without a Galvano scanner may be also used. For another example, laser processing technology with spatial phase modulator or holographic optics may be used. Preferably, the laser processing may include interfering laser beams to create the deletion. Interfering lasers may provide a stable, energy efficient system over a focused laser beam. An axicon lens may be used to create the deleted openings described herein with interfering laser beams. Further, the interfering beams may be focused on the coating such that openings may be reliably formed on a three-dimensionally bent glass substrate.

The opening(s) may further be formed by physical abrasion of any suitable form, including scratching of the surface. Chemical etching may further be used to form the openings. Chemical etching may include the use of a mask to isolate the location of the opening(s). Chemical etching may further include the use of an oil pen to draw the etched pattern onto a coating. Further, a coating may be opened using a combination of any deletion methods.

Once the opening 132 is formed, a connection may be made to the exposed conductive layers as shown in FIG. 6. In the shown example, a copper tape 136 having a conductive carrier 134 on a back side of the tape may be employed for this connection. The copper tape 136 is replaceable with other electrical connection means such as a metal plate or foil. The copper tape 136 may include the conductive carrier 134 serving as an adhesive on an underside of the connector (copper tape) which may entirely or at least partly fill the opening 132 created in the coating. In a preferred embodiment, the conductive carrier 134 may be covered with a release paper or film before it is applied over the opening 132. Such a release paper may be removed from the conductive carrier 134 prior to the conductive carrier 134 being applied onto the surface of the coating, over the opening 132. The conductive carrier 134, as described above, may include metallic particles or any other conductive material. In some embodiments, the conductive carrier 134 may include silver particles but may include other particles of a metal such as gold, palladium, nickel, copper, zinc, tin, or metal alloys, and further carbon particles such as graphite, graphene, carbon nanotube, and combinations thereof. When the copper tape 136, or other connector, is applied over the opening 132, the conductive carrier 134 may change its shape as to conform or partially conform to the shape of the opening 132. The inner side surface of the opening 132 may thus contact the conductive carrier 134. In some embodiments, pressure applied to the copper tape 136, or other suitable connector, which may push the conductive carrier 134 into or further into the opening 132. The conductive carrier 134 may include a resin vehicle such as acrylic resin, epoxy resin, silicone resin, poly carbonate resin and other resins similarly suitable for resin vehicle.

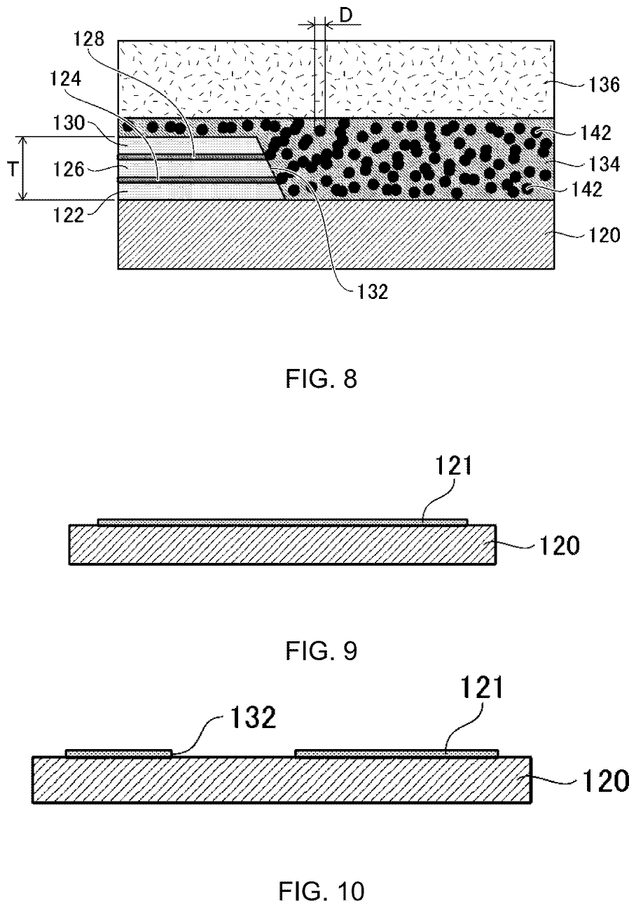

FIG. 8 illustrates a cross section of the area at which the opening 132 is formed. Because the conductive layer in the coating, or namely, the lower silver layer 124 and the upper silver layer 128 are relatively thin layers having the thickness of 9 to 12 nano meters, if the conductive carrier 134 contains relatively large size conductive particles, the conductive particles may be less likely to contact the exposed end of the silver layers 124, 128, which may decrease an electrical connection between the conductive particles and the silver layers 124, 128. The large diameter may space the conductive particles apart and limit the possible surface area of the particles from connecting to the silver layers 124, 128. In some embodiments, the conductive particles in the conductive carrier 134 may be selected to have a relatively small diameter as to make an efficient electrical connection between the copper tape 136 and the silver layers 124, 128. Where the total thickness T of the coating is about 150 to 250 nanometers for double silver coatings, or about 300 to 500 nanometers for triple silver coatings, conductive particles in a conductive carrier 134 may have a mean diameter D of 3 to 50 nano meters, preferably 5 to 20 nano meters, and more preferably 7 to 15 nano meters. The density of the conductive particles in the conductive carrier 134 may further affect the connection to the heatable coating. The conductive particles may have a density such that the electrical current may pass from the copper tape 136 and the silver layers 124, 128. Preferably, the conductive particles physically contact each other to pass the electrical current therebetween. A desirable particle size may depend on the thickness of the coating, and may change according to the thickness of the sliver layers or any other factors. In some embodiments, metal particles having a diameter of 35 to 90 microns may be readily used in a conductive carrier. The mean diameter D may be measured by a microscope or electron microscope to calculate a mean value of the shortest diameter and the longest diameter of the observed conductive particles in the conductive carrier.

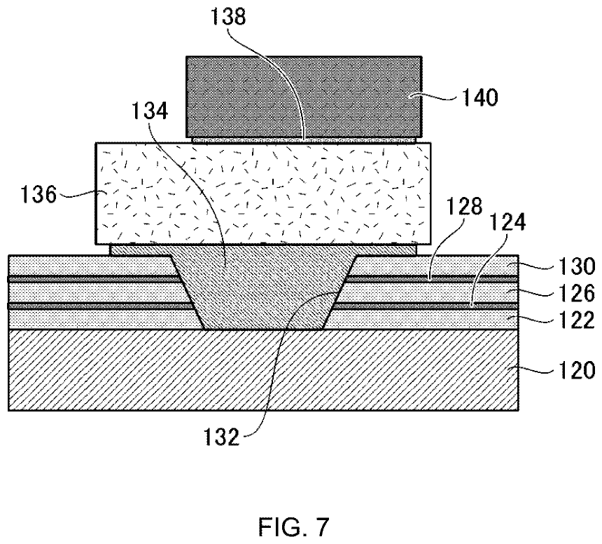

After the copper tape 136 is positioned over the opening 132, a connector 140 may be provided on the front surface of the copper tape 136 as shown in FIG. 7. In particular embodiments, the connector 140 may be soldered onto the copper tape 136, which may include a lead free solder 138 as shown in FIG. 7. The connector 140 may be any suitable connector, such as a flex connector.

The busbar formed by such methods may not be exposed to temperatures higher than the glass softening point which may otherwise affect bending of the glass substrate in the area of the busbar.

In a further detailed example, FIG. 9 to FIG. 14 show cross-sectional process diagrams of connecting a heatable coating on a vehicle glazing. First, a glass substrate 120 may be prepared having a conductive coating 121 formed thereon. The conductive coating 121, which may be a heatable coating, may be formed on any suitable substrate, including glass or a polymer film. For example, the conductive coating may be formed on a polyethylene terephthalate (PET) film, which may be laminated within a glazing. Where the coating is applied to a glass substrate, the coating may be applied to any glass surface. Where a first glass substrate having surfaces S1 and S2 is provided on an exterior side of a vehicle glazing, the surface S1 faces the vehicle exterior, whereas a second glass substrate having surfaces S3 and S4 is provided on an interior side of the vehicle glazing, the surface S4 faces the vehicle interior. In a laminated glazing, preferably the coating is on at least one of surfaces S2, S3, and S4. Where the coating is formed on surface S3, an opaque enamel (e.g., black enamel printing) may be provided on surface S2 of the first glass substrate. The glass substrate 120 may have a thickness of 0.05 mm to 10 mm, preferably 0.5 mm to 3.0 mm, and more preferably 1.0 mm to 2.4 mm. In some embodiments, including in laminated glazings, a glass substrate may have a thickness of 0.05 mm to 2.4 mm, preferably 0.5 mm to 1.8 mm, and more preferably 1.0 mm to 1.6 mm.

The heatable coating 121 may be formed on a surface of the glass substrate 120, e.g., the surface S3 of the second glass substrate. The heatable coating 121 having conductive layers may be deposited by any suitable means, including physical vapor deposition or atomic layer deposition, without limitation as shown in FIG. 9.

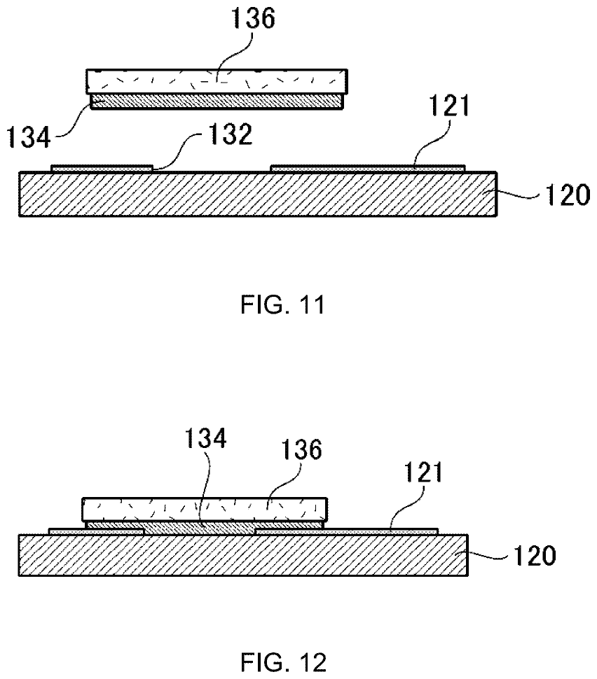

After forming the heatable coating 121, an opening 132 may be formed in the heatable coating 121 as shown in FIG. 10. The glass substrate 120 may be bent before or after forming the opening 132 in the heatable coating 121. The opening 132 may be formed by a laser etching process in some embodiments to expose an end of the conductive layers of the heatable coating 121 within the opening 132.

Where the opening 132 is formed, a connector 136 having a conductive carrier 134 may be positioned as shown in FIG. 11. The connector 136 may preferably include a metallic foil, such as a copper tape, or a metal plate. In FIG. 11, the connector 136 shown in a copper tape. The conductive carrier 134 may include metal particles (e.g., silver particles) or otherwise conductive particles for efficient electrical conductivity dispersed in the adhesive vehicle such as acrylic, epoxy, and silicone resin. In a typical procedure, the connector 136 may have an adhesive back which is positioned facing the opening 132. When the copper tape 136 is applied directly over the opening 132, the opening 132 may be filled or partially filled with the conductive carrier 134.

FIG. 12 shows a cross section at which the copper tape 136 is adhered to the opening 132. With this attachment, the copper tape 136 may be electrically connected to the conductive layers in the heatable coating 121 without subjecting the busbar to a high temperature reached when bending the glass substrate.

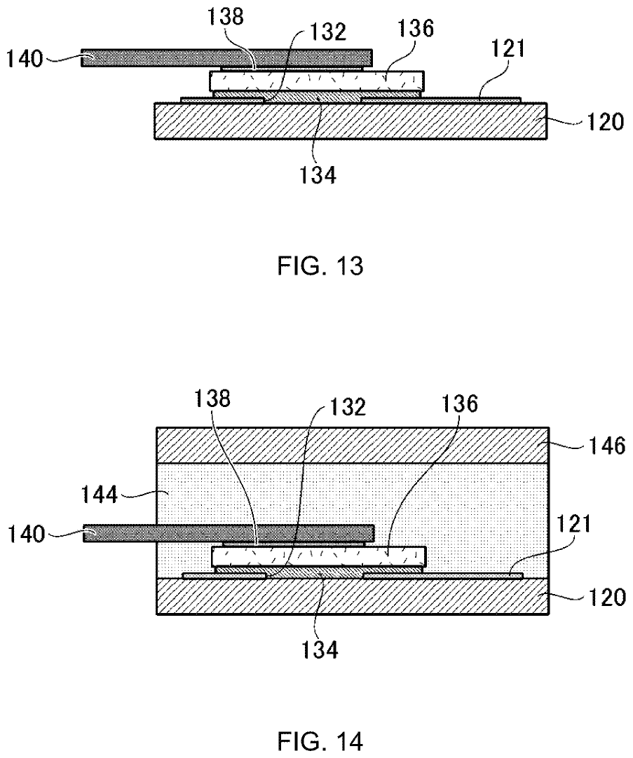

After the copper tape 136 and the conductive layers in the heatable coating 122 are electrically connected, a connector 140 may be provided on the copper tape 136 as shown in FIG. 13, as corresponding to FIG. 7. In particular examples, the connector 140 may be a flex connector. The connector 140 may be soldered to the copper tape 136, which may include a lead free solder 138 as shown in FIG. 13. The lead free solder 138 may be applied via typical soldering methods.

Where the heatable coating is to be positioned inside a laminated glazing, the connector 140 may covered with a PVB interlayer 144. A glass substrate 146 may then be positioned over the PVB interlayer 144 such that the interlayer 144 is positioned between the first and second glass substrates 120, 146, as shown in FIG. 14. Such a lamination stack of glass substrates 120, 146 and interlayer 144 may be laminated together to provide a glazing.

It is to be noted that in the embodiment thus described, the substrate 120 is made of an inorganic glass material, but as described herein, the substrate may be formed of a material other than inorganic glass, e.g., such as an organic glass or polymer material film or plate. Such an organic glass or polymer material may include a film or plate of an acrylic resin, a polycarbonate resin, or any other suitable resin materials or resin-glass hybrid material.

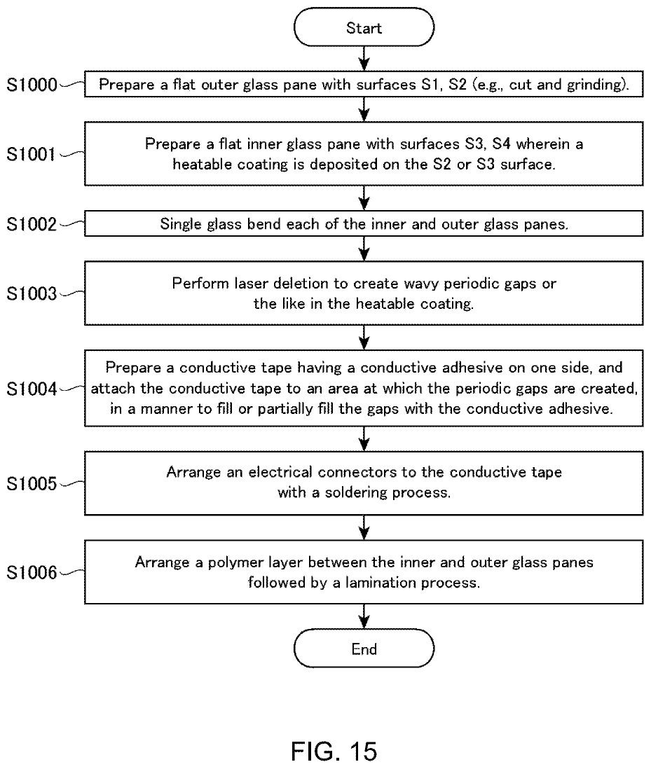

According to aspects of the present disclosure, referring to FIG. 15, a manufacturing process of a conductive laminated vehicle window, having a conductive coating on a glass surface may comprise the following steps.

Step S1000 includes a step for preparing a flat outer glass pane with surfaces S1, S2 (e.g., cut and grinding).
Step S1001 includes a step for preparing a flat inner glass pane with surfaces S3, S4 wherein a heatable coating is deposited on the S2 or S3 surface. The heatable coating may be deposited by any suitable means, including physical vapor deposition or atomic layer deposition, without limitation, and may include a heatable IRR coating.
Step S1002 includes a step for bending a single glass, each of the inner and outer glass panes, respectively, by, for example, a mold press bending. In some embodiments, the glass may be bent as a pair.
Step S1003 includes a step for performing laser deletion to create, e.g., wavy periodic gaps or the like in the heatable coating. In some alternative embodiments, the laser deletion may be performed prior to the glass bending process.
Step S1004 includes a step for preparing a conductive tape having a conductive adhesive on one side and attaching the conductive tape to an area in which the periodic gaps are created, in a manner to fill or partially fill the gaps with the conductive adhesive.
Step S1005 includes a step for attaching an electrical connector to the conductive tape with a soldering process. For example, an electrically conductive copper foil may be adhered to the coating across the openings, and then a suitable connector may be soldered on the copper foil.
Step S1006 includes a step for arranging a polymer layer (e.g., polyvinyl butyral, PVB, sheet of about 0.8 mm thickness) between the inner and outer glass panes followed by a lamination process (e.g., autoclaving).

In further embodiments, the laser deletion may form a linear deletion. The deletion may further be formed by physical abrasion or chemical etching. The deletion may further include separated vertical pillars within the coating.

Other conductive coatings may further be used in the disclosed methods. For example, the coating may comprise an infrared reflective coating, a nanowire coating, or a low-emissivity coating. The coating may be heatable and/or act as a source of electrical power. Any suitable glass substrate may be used in the constructions disclosed herein.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. For example, without limitation, the deletion disclosed in the present disclosure may be also applicable to deletion to create integrated antenna circulate (or lines) in a heatable laminated glazing (not limited to windshields) with a heatable IRR coating comprising double, triple, or more silver functional layers. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A method for producing an electrically connectable coated substrate, the method comprising:
providing a conductive coating having a conductive material on a surface of a substrate;
forming an opening in the coating; and
applying an electrical connector having a conductive carrier on one side of the electrical connector to the conductive coating over the opening,
wherein the conductive carrier at least partially fills the opening, whereby the conductive material is electrically connected to the electrical connector.

2. (canceled)

3. The method according to claim 1, wherein the conductive coating is selected from the group consisting of an infrared reflective coating, a nanowire coating, a low-emissivity coating, and a transparent conductive oxide.

4. (canceled)

5. The method according to claim 1, wherein the conductive coating comprises at least one conductive layer.

6-7. (canceled)

8. The method according to claim 1, wherein the opening comprises a wave structure having a frequency-type shape, wherein the frequency-type shape comprises at least one of a sinusoidal wave form, a triangle wave form or a quadrangular wave form.

9. The method according to claim 1, wherein the opening has a pattern of a periodic structure.

10. The method according to claim 9, wherein the pattern is formed across a busbar area for electrical connection.

11. The method according to claim 1, wherein the opening extends in a linear shape.

12. (canceled)

13. The method according to claim 1, wherein forming the opening includes laser etching, physical abrasion or chemical etching.

14-15. (canceled)

16. The method according to claim 1, wherein the substrate is made of any one of a glass substrate, a polymer film, and a polymer plate.

17. The method according to claim 1, wherein the conductive carrier includes conductive particles dispersed therein.

18-20. (canceled)

21. The method according to claim 1, wherein a top layer of the conductive coating is electrically non-conductive.

22. The method according to claim 1, further comprising soldering a flex connector to the electrical connector.

23. An electrically connected coated substrate, comprising:
a substrate;
a conductive coating formed on the substrate, the conductive coating being formed with an opening to expose a conductive material in the conductive coating; and
an electrical connector having a conductive carrier on one side of the electrical connector, the electrical connector being positioned on the coating directly over the opening such that the conductive carrier at least partially fills the opening.

24-25. (canceled)

26. The electrically connected coated substrate according to claim 23, wherein the coating is selected from the group consisting of an infrared reflective coating, a nanowire coating, a low-emissivity coating, and a transparent conductive oxide.

27-33. (canceled)

34. The electrically connected coated substrate according to claim 23, wherein the substrate is made of any one of a glass substrate, a polymer film, and a polymer plate.

35. The electrically connected coated substrate according to claim 23, wherein the conductive carrier includes conductive particles dispersed therein.

36-38. (canceled)

39. The electrically connected coated substrate according to claim 23, wherein a top layer of the coating is electrically non-conductive.

40. The electrically connected coated substrate according to claim 23, wherein the electrical connector is a copper tape.

41. The electrically connected coated substrate according to claim 40, further comprising a second connector attached to the copper tape.

42. (canceled)

43. A vehicle glazing, comprising:
a first glass substrate;
a second glass substrate; and
at least one polymer interlayer between the first glass substrate and the second glass substrate,
wherein at least one of the first glass substrate and the second glass substrate comprises the electrically connected coated substrate according to claim 23.

44. The vehicle glazing according to claim 43,
wherein the first glass substrate has a S1 surface facing a vehicle exterior and a S2 surface opposite the S1 surface,
wherein the second glass substrate has a S3 surface and a S4 surface opposite the S3 surface and facing a vehicle interior, and
wherein the coating is provided on a surface selected from the group consisting of the S2 surface of the first glass substrate and the S3 surface of the second glass substrate.

45. The vehicle glazing according to claim 44, wherein the coating is provided on the S3 surface of the second glass substrate.
